(19) United States
(12) Patent Application Publication
(10) Pub. No.: US 2006/0021028 A1
(43) Pub. Date: Jan. 26, 2006

(54) System and method for adaptive policy and dependency-based system security audit

(76) Inventors: Glenn M. Brunette, Medford Lakes, NJ (US); Alexander A. Noordergraaf, Meredith, NH (US)

Correspondence Address: HOGAN & HARTSON LLP, ONE TABOR CENTER, SUITE 1500, 1200 SEVENTEEN ST., DENVER, CO, 80202, US

(21) Appl. No.: 10/402,576

(22) Filed: Mar. 28, 2003

(51) Int. Cl. G06F 12/14

(52) U.S. Cl. 726/22

(57) ABSTRACT

A computer security verification method that includes the steps of determining whether a program is installed on a target system, where, if the program is not installed, then the verification method terminates with a message indicating that the program is not installed, and verifying a configuration of the program when the program is installed on the system. Also, a computer security verification method that includes the steps of comparing one or more configuration parameters with a configuration of a target system, and verifying that a running state of the system matches the configuration of the system.

### BACKGROUND OF THE INVENTION

1. Field of the Invention

The present invention relates, in general, to methods and systems to audit and validate the security of a computer system. More specifically, the present invention includes methods and systems to audit and validate security that are based on security option dependencies and configurations defined by a security policy for the computer system.

2. Relevant Background

Maintaining security is an ongoing process and is something that needs to be reviewed and revisited periodically. Maintaining a secure system requires vigilance, because the default security configuration for any system tends to become increasingly open over time.

One aspect of maintaining security is a periodic audit, also known as security verification, of the security posture of the system. The frequency of an audit depends on the criticality of the environment and the security policy of the system operator. Some operators run audits every hour, every day, or even once every month. An operator may run a mini-scan (having a limited number of checks) each hour, and a full scan (using all possible checks) each day. In addition to periodic audits, audits are also recommended after upgrades, patches and other significant system configuration changes.

If the security posture of a system is not periodically audited, then configurations often drift over time due to entropy or modifications that unknowingly or maliciously change the desired security posture. Without a periodic audit, these changes can go undetected and corrective measures are not taken. The result is a system that becomes less secure, and therefore more vulnerable, over time.

One problem with security audits in the past has been the lack of adaptability of audit programs to large networks with highly differentiated systems. In a large network the functions and configurations of individual target systems are rarely uniform, and audit programs become very inefficient because of the differences between target systems.

For example, if two or more system administrators oversee separate parts of a network, a security audit program should be aware of the different security privileges each administrator can have on each target system in that network. If code has to be modified to account for the security policy differences in the target systems, then the program will have poor scalability for a large and growing network.

Another problem with security audits has been the inability to detect inconsistencies between stored and running system configurations. A stored system configuration may have a particular program disabled because it makes the network vulnerable, but it still may be run on occasion because it is convenient. Rebooting the target system terminates the program, but a long period of time may elapse before a system reboot in a large network. In this situation, prior security programs that would only check the stored system configuration, but not the running configuration, could incorrectly certify that the target system is secure.

For example, a system administrator may start a TELNET session to access a system quickly from another system that does not have a Secure Shell client. The administrator may then forget about the open session before shutting it down. Thus, a TELNET session continues to run on the target system even though the stored configuration files indicate that TELNET service is disabled. An attacker conducting a port scan may notice the open session and exploit a security flaw to gain access to the entire network. A security audit program would falsely certify the target system as safe from this kind of attack because the program did not check the running system configuration.

Still another problem with security audits has been the inability to check to see if a program is installed on a target system before conducting a security check on various aspects of the program. For example, a security audit program automatically checks for various files of a program on a target system even if the program has never been installed on that system. The result is a flurry of security alerts indicating failed security checks for various program components, when in fact the only relevant information is that the program is not installed on the target system. There remains a need in the art to address these and other problems with security audits.

### SUMMARY OF THE INVENTION

Briefly stated, one embodiment of the invention is a computer security audit method that includes the step of determining whether a program is installed on a target system, and if the program is not installed, then terminating the audit method with a message indicating that the program is not installed. The method also includes verifying a configuration of the program when the program is installed on the system.

Another embodiment of the invention is a security audit method that includes the steps of determining whether the program is running on the target system during the audit method, and verifying a security configuration for the running program.

Still another embodiment includes a system for a computer security audit that includes one or more target computers, and a script to run on at least one of said target computers, where the script determines whether a program is installed on the target computer and terminates if the program is not installed. The script verifies a security configuration of the program when the program is installed on the target computer.

Additional novel features shall be set forth in part in the description that follows, and in part will become apparent to those skilled in the art upon examination of the following specification or may be learned by the practice of the invention. The features and advantages of the invention may be realized and attained by means of the instrumentalities, combinations, and methods particularly pointed out in the appended claims.

### BRIEF DESCRIPTION OF THE DRAWINGS

FIG. 1 shows a flowchart diagram for a method of performing a security audit according to an embodiment of the invention; and

FIG. 2 shows a security profile hierarchy according to an embodiment of the invention.

### DETAILED DESCRIPTION OF THE PREFERRED EMBODIMENTS

The computer security audit methods of the present invention may include performing a periodic security assessment on target systems to provide a benchmark of how closely the security matches a security profile implemented on the system. The security assessment may also be performed after a predefined event, such as the installation of a new piece of software on a target system, or after the hardening of a target system.

For example, security assessments may be performed as a security maintenance task after the hardening of a new installation. At the software level, the security assessment may use the same security profiles that are used to harden the target system, except that the profiles are configured to operate in an audit mode instead of hardening mode. The audit mode configured security profiles check the current state of the target system instead of hardening the system by modifying files, programs, scripts, etc. on the target system. In another example, a security assessment may be performed after a target system has been deployed, but before the system has been hardened.

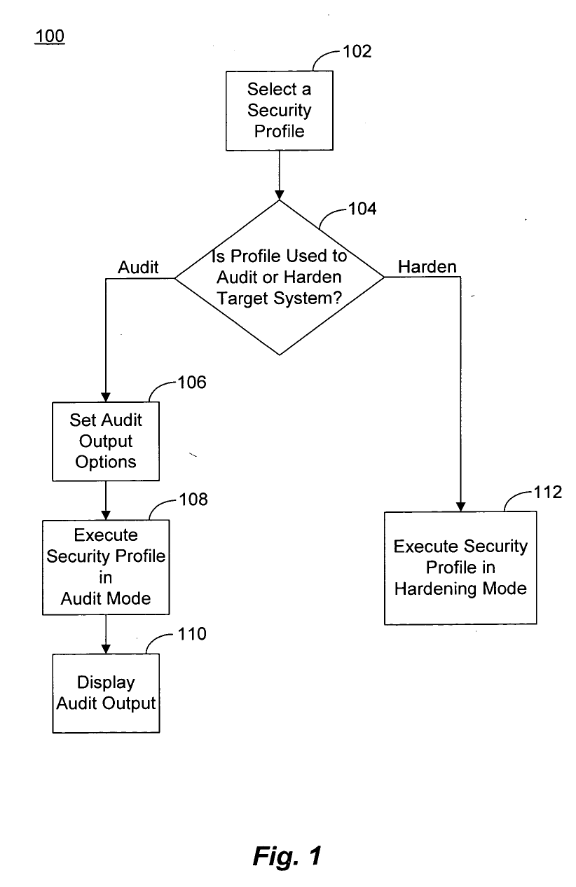

As shown in the flowchart of FIG. 1, performing a security audit may start with selecting the security profile 102, which may also be a hardening profile, for the audit. The selected security profile may be a user created template, a custom security profile developed from predefined templates, or a standard or product-specific profile, among other kinds of profiles.

The selected security profile may be used in a security audit of the target system or used to harden the system. The decision 104 between auditing and hardening may be implemented by appending some kind of indicia to a command to execute the security profile. For example, a “-v” or “-a” may be appended to the execute command to indicate that the security profile will run in an audit mode rather than a hardening mode.

Once the decision 104 about the execution mode has been made, the selected security profile will be executed either in audit mode 108 or hardening mode 112. When the audit mode 108 is executed, files from an audit directory on the target system may be accessed to perform the security audit. Control scripts used in audits and finish scripts may share the same base filenames but can be distinguished by appending a different suffix to the base filename. For example, a “driver.run” script may automatically translate finish scripts defined by a variable into audit scripts by changing the suffix appended to the filename from “.fin” to “.aud”.

The security audit may start by running a selected security profile and audit output options. Each profile script that is accessed during the run may evaluate the state of all of its templates and verify scripts. Each check results in a state of success or failure that may be represented by, for example, a security vulnerability value of 0 or non-zero, respectively.

Each script that is run may produce a total security score, based on the total vulnerability value of each check contained within a script. The total vulnerability value for each security profile may be displayed at the completion of the profile's security assessment. A grand total of all scores may be presented at the end of the run.

The security audit of the present invention may check both the stored state of the target system by inspecting configuration files and the running state of the system by inspection process table information, device driver information, etc. The security audit may not only check for the existence of a file or service, but also check whether the software associated with the file or service is installed, configured, enabled, and running on the target system.

When the decision 104 has been made to run the security profile in audit mode 108, the options for the audit output may also be selected 106. Audit output options include, without being limited to, mailing the audit output to one or more designated email addresses and delivering the audit output to a file through one or more designated file paths.

The verbosity of the audit output may also be specified for an audit run in order to control amount of output information displayed 110. For example, if there are 500 target systems being audited, it may be desirable to limit the displayed output for each system to a single line indicating whether the system has passed or failed the security audit. Then, for the systems that fail the security audit, it may be desirable to expand the amount of displayed audit output information, especially in the areas where the audit failure occurred. In another example, sometimes called the quiet option, no audit output information is displayed, and audit failures may be corrected automatically. Table 1 shows an example that includes five verbosity levels for the display 110 of audit output:

TABLE 1
AUDIT VERBOSITY LEVELS

| Level | Output |
|---|---|
| 0 | Single line indicating pass or fail |
| 1 | For each script, a single line indicating pass or fail. One |
| | grand total score line below all the script lines. |
| 2 | For each script, provides results of all checks. |
| 3 | Multiple lines providing full output, including banner and |
| | header messages. |
| 4 | Multiple lines (all data provided from level 3) plus all |
| | entries that are generated by a logging function. This is the |
| | level for debugging. |

The messages displayed in the audit output may also be user specified. For example, pass messages may be omitted so that only fail messages will be displayed. The messages may be controlled through a logging variable that does not display a message when the value is 0, and does display a message when the value is 1. Table 2 shows an example of some logging variables used to control the display of messages in the audit output.

TABLE 2
DISPLAYING MESSAGES IN AUDIT OUTPUT

| Logging Variable | Log Prefix | Description |
|---|---|---|
| JASS_LOG_BANNER | All Banner | This parameter controls the |
| | Output | display of banner messages. |
| | | These messages are usually |
| | | surrounded by separators |
| | | comprised of either equal |
| | | sign (“=”) or dash (“-”) |
| | | characters. |
| JASS_LOG_ERROR | [ERR] | This parameter controls the |
| | | display of error messages. |
| | | Error messages are generated |
| | | when the program detects a |
| | | recoverable error during its |
| | | processing. If the error were |
| | | unrecoverable, the program |
| | | would exit and therefore be |
| | | unable to log any further |
| | | messages. If set to 0, no error |
| | | messages will be generated. |
| JASS_LOG_FAILURE | [FAIL] | This parameter controls the |
| | | display of failure messages. |
| | | Failure messages are generated |
| | | as a when verification or |
| | | auditing check determines the |
| | | parameter checked does not |
| | | match the value expected. If |
| | | set to 0, no error messages |
| | | will be generated. |
| JASS_LOG_NOTICE | [NOTE] | This parameter controls the |
| | | display of notice messages. |
| | | Notice messages are generated |
| | | to provide information to the |
| | | operator. These messages |
| | | generally provide information |
| | | about a verification or |
| | | auditing check, its purpose, |
| | | or the state of a parameter |
| | | when it is not appropriate to |
| | | provide a success or failure |
| | | message. These messages can be |
| | | used whenever information is |
| | | presented to an operator as |
| | | long as one of the other |
| | | message formats is not a better |
| | | fit. If set to 0, no notice |
| | | messages will be generated. |
| JASS_LOG_SUCCESS | [PASS] | This parameter controls the |
| | | display of success or passing |
| | | status messages. Success |
| | | messages are generated as a |
| | | when verification or auditing |
| | | check determines the parameter |
| | | checked matches the value |
| | | expected. If set to 0, no |
| | | success messages will be |
| | | generated. |
| JASS_LOG_WARNING | [WARN] | This parameter controls the |
| | | display of warning messages. |
| | | Warning messages are generated |
| | | when the program detects a |
| | | problem during its processing. |
| | | Warning messages differ from |
| | | error messages in that the |
| | | severity attributed to warning |
| | | messages is typically less |
| | | than for error messages. Also, |
| | | warning messages are used to |
| | | convey a warning to the |
| | | operator regarding some event |
| | | or issue detected by the |
| | | program. If set to 0, no |
| | | warning messages will be |
| | | generated. |

The audit output may also include displayed information identifying the host (e.g., target system), script name and timestamp information. Table 3 shows an example of variables used to control this information:

TABLE 3
HOST NAME, SCRIPT NAME AND TIMESTAMP AUDIT OUTPUT

| Variable Name | Description |
|---|---|
| JASS_DISPLAY_HOSTNAME | The JASS_HOSTNAME parameter is typically |
| | assigned the name of the system being examined. |
| | This name can be either a short (unqualified |
| | respresentation) or a fully-qualified domain |
| | name. |
| | Setting this parameter to 1 prepends each log |
| | entry with the host name of the target system. |
| | This information is based on the |
| | JASS_HOSTNAME parameter. By default, this |
| | parameter is empty, and the information is not |
| | displayed. |
| JASS_DISPLAY_SCRIPTNAME | By default, this parameter is set to 1, so each |
| | log entry is prepended with the name of the |
| | verification script currently being run. Setting |
| | this parameter to any other value will cause the |
| | information not to be displayed. |
| JASS_DISPLAY_TIMESTAMP | The JASS_TIMESTAMP parameter is typically |
| | assigned a fully qualified time value |
| | determined by the system being examined. This |
| | parameter takes the form of the following string: |
| | YYYYMMDDhhmmss. That is, a four digit year, |
| | a two digit month, a two digit day, a two digit |
| | hour, a two digit minute and a two digit second. |
| | For example, Apr. 1, 1983 at 12:34 PM would be |
| | represented as: 19830401123400. Setting this |
| | parameter to 1 causes each log to be prepended |
| | with the timestamp associated with the |
| | verification run. This information is based on |
| | the JASS_TIMESTAMP parameter. By default, this |
| | parameter is empty, so the information is not |
| | displayed. |

The host, script and timestamp data may be combined from security audits on many target systems and sorted based on key data. For example, the data can be used to examine whether a system build or other kind of deployment process is resulting in the same failed check (or checks) on target systems.

As noted above security audits benchmark the security level of a target system against a security profile implemented on the system. The security profile may be based on a predefined profile template, or a user defined and/or user updated security profile.

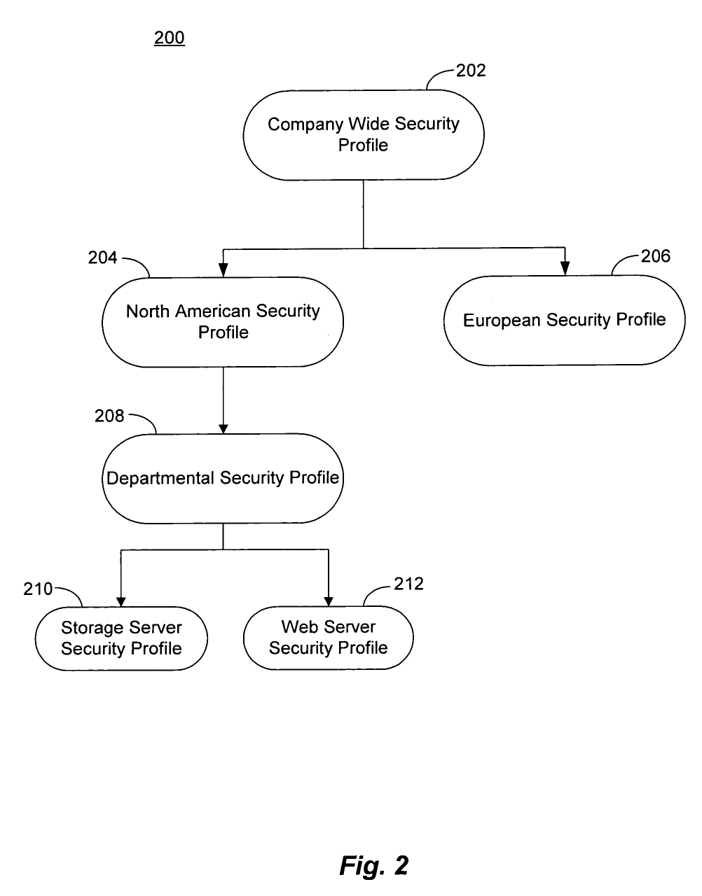

The security profiles implemented on target systems may have a hierarchical organization where the complete security profile on a target system may include security profiles implemented on every system in the network as well as security profiles for selected sub-sets of systems on the network. For example, as shown in the security profile hierarchy 200 in FIG. 2, a company wide security profile 202 may be installed on every system in the network. The company wide security profile 202 includes the highest-level security policies for the network, which cannot be modified by lower level security profiles. Similarly, the company wide security profile 202 overrides any contradictory policies found in the lower-level security profiles.

In the next level of the profile hierarchy 200, the security profiles have been geographically divided into a North American security profile 204 and a European Security profile 206. At this level, all systems in the North American sub-network have a security profile that includes both the company wide security profile 202 and the North American security profile 204. Similarly, all systems in the European sub-network include the company wide security profile 204 and the European security profile 206.

There may be any number of policy differences between the North American security profile 204 and European Security profile 206 that may include, without being limited to, date formatting and timestamp policies, employee privacy policies, administrator access policies, etc. As noted above, however, the systems on both geographical sub-networks share the same company-wide policies.

In the example illustrated in FIG. 2, a departmental security profile 208 is installed on a subset of the systems that include the North American security profile 204. The departmental security profile 208 may be installed on those systems used by a single department in the North American portion of the company wide network, and may include security policies specific to that department.

For example, there may be one department that deals with confidential company information and needs much more restrictive access privileges than is desirable for the rest of the network. The hierarchical organization of security profiles in the present invention permits the implementation of a company wide security policy across all systems on the network while simultaneously implementing additional security policies on selected sub-networks, such as a selected departmental network, where appropriate.

In the example, the departmental sub-network is further divided into a storage server and a web server. Each server may have security issues that are not applicable to the other. Accordingly, a storage server security profile 210 is implemented on systems that include the storage server and a web server security profile 212 is implemented on systems that include a web server. Both profiles 210, 212 are implemented on top of the department security profile 208, which is implemented on top of the North American security profile 204, which in turn is implemented on top of the company wide security profile 202.

It should be appreciated that the example hierarchy of security profiles shown in FIG. 2 is but one of a virtually unlimited number of examples. An organization with uniform security requirements may develop a security policy with a single security profile, while a large organization with a complex security policy may develop a much more elaborate security profile hierarchy than the one shown in FIG. 2. It is also possible to have one or more security profiles implemented on a flat hierarchy that has all systems on one network level.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

The words “comprise,” “comprising,” “include,” “including,” and “includes” when used in this specification and in the following claims are intended to specify the presence of stated features, integers, components, or steps, but they do not preclude the presence or addition of one or more other features, integers, components, steps, or groups.

We claim:

1. A computer security audit method comprising:
determining whether a program is installed on a target system, wherein if the program is not installed then the verification method terminates with a message indicating that the program is not installed; and
verifying a configuration of the program when the program is installed on the system.

2. The method of claim 1, comprising determining whether the program is enabled to run on the target system.

3. The method of claim 1, wherein said verifying of the configuration of the program comprises executing a script that compares one or more configuration parameters with the configuration of the program.

4. The method of claim 3, wherein said one or more configuration parameters is located in a policy file that is separate from the script.

5. The method of claim 4, wherein said policy file is stored on the target system.

6. The method of claim 3, comprising determining whether said comparison of each configuration parameter with the configuration of the program is a success or a failure.

7. The method of claim 6, comprising counting the number of successes and the failures, wherein a security score is assigned to the program based on the count of the successes and the failures.

8. The method of claim 1, wherein the program comprises software service, an operating system or an application program.

9. The method of claim 8, wherein said application program comprises a word processing application, a spread-sheet application, a database application, a file sharing application, or a file transfer application.

10. The method of claim 8, wherein said software service comprises a web server, a file transfer protocol server, or a database server.

11. The method of claim 1, comprising:
determining whether the program is running on the target system during the verification method; and
verifying a security configuration for the running program.

12. A computer security audit method comprising:
comparing one or more configuration parameters with a configuration of a target system; and
verifying that a running state of the system matches the configuration of the system.

13. The method of claim 12, comprising reporting a mismatch between the configuration state and the running state of the target system.

14. The method of claim 13, wherein said mismatch comprises a program running on the system when the configuration state indicates that execution of said program is disabled.

15. The method of claim 12, wherein a script is used for the comparing of said one or more configuration parameters with the configuration of the target system.

16. The method of claim 15, wherein said one or more configuration parameters are in a policy file, and wherein the policy file is separate from the script.

17. The method of claim 16, wherein the policy file is stored on the target system.

18. A system for computer security audits comprising:
one or more target computers;
a script to run on at least one of said target computers, wherein said script determines whether a program is installed on the target computer and terminates if said program is not installed, and wherein said script verifies a security configuration of the program when the program is installed on the target computer.

19. The system of claim 18, wherein each of said one or more target computers comprises a configuration parameter that the script compares to the security configuration of the program to verify the security configuration of the program.

20. The system of claim 19, wherein the configuration parameter is stored in a policy file.

21. The system of claim 20, wherein the policy file is separate from the script.

22. The system of claim 18, wherein the program comprises a software service, an operating system or an application program.

23. The system of claim 22, wherein said application program comprises a word processing application, a spread-sheet application, a database application, a file sharing application, or a file transfer application.

24. The system of claim 22, wherein said software service comprises a web server, a file transfer protocol server, or a database server.
